(19) United States
(12) Patent Application Publication
(10) Pub. No.: US 2005/0096012 A1
(43) Pub. Date: May 5, 2005

(54) Authentication and/or billing mediation service apparatus and method

(75) Inventors: Michael Borella, Naperville, IL (US); Guanglu Wang, Buffalo Grove, IL (US); Ali Akgun, Chicago, IL (US)

Correspondence Address: FITCH EVEN TABIN AND FLANNERY, 120 SOUTH LA SALLE STREET, SUITE 1600, CHICAGO, IL, 60603-3406, US

(73) Assignee: UTStarcom Incorporated

(21) Appl. No.: 10/698,272

(22) Filed: Oct. 31, 2003

(51) Int. Cl. H04M 1/66

(52) U.S. Cl. 455/411

(57) ABSTRACT

A mobile unit (14) that seeks to make use of near-real-time multicast communication services via a corresponding services server (13) can effect at least a measure of authentication with a session initiation protocol infrastructure via a RADIUS server (12) through intermediation of a mediation server (10). In addition, or in lieu thereof, billing for such services can be facilitated through the mediation server (10).

### TECHNICAL FIELD

This invention relates generally to Internet Protocol (IP) compatible sessions and more particularly to authentication and billing activities.

### BACKGROUND

IP based communication systems are well known and many well-established protocols and interfaces are defined to facilitate a variety of communications. For example, remote authentication dial-in user service (RADIUS)-compatible servers (such as authentication, authorization, and accounting servers (AAA's)) are known that utilize RADIUS communication protocols to facilitate authentication of a given user with respect to a given communication session. There are also ongoing proposals to develop and offer additional IP-compatible functionality and/or services. For example, near-real-time multicast communication services, such as so-called walkie-talkie services that permit two-way communications between or amongst two or more grouped mobile units, have been proposed.

At present, such services are typically based on session initiation protocol (SIP) call establishment and management methodologies. This has the benefit of permitting, for example, reuse of a widely dispersed existing SIP infrastructure. This SIP infrastructure can serve to support voice-over-Internet-Protocol (VoIP) calls, instant messaging, video conferencing, data streaming, and so forth amongst predefined groups of users. When facilitating such services, user authorization and/or billing are often significant design requirements. SIP in turn provides specific ways by which authentication can be achieved (one such mechanism, entitled “HTTP Digest Authentication,” is defined in the RFC2617 specification).

Unfortunately, though widespread, SIP does not represent a universal solution and platform enabler. Many system infrastructures, and especially IP-based systems, use alternative mechanisms. For example, to facilitate user authorization, IP-based systems often employ RADIUS-compatible servers such as the relatively ubiquitous AAA server. Such RADIUS servers do not use an SIP-compatible communication mechanism and in particular do not support present SIP authorization procedures. Such circumstances make it difficult to involve a RADIUS server in the SIP authentication process. For example, no useful way to readily translate an SIP-friendly HTTP digest expression into a RADIUS-friendly CHAP-style digest exists, and in particular there have been no useful suggestions of how to readily derive an SIP password from the so-called CHAP-based chap_secret expression.

In a similar manner, presently proposed or commercially available near-real-time multicast communication service servers do not support RADIUS protocols and communication methodologies. Consequently, billing for services such as near-real-time multicast communication services often tends to be based upon a fixed fee as the per-call information that would be necessary to inform another approach is simply not usually available.

It should therefore be evident that existing RADIUS servers, including AAA servers as are commonly otherwise used to facilitate various IP-based communications, are not readily adapted for use with SIP-based services such as near-real-time multicast communication services (including but not limited to so-called walkie-talkie services). Instead, authorization and authentication can present a difficult challenge and billing is often relegated to a relatively one-dimensional and simple construct for lack of a suitable support mechanism.

### BRIEF DESCRIPTION OF THE DRAWINGS

The above needs are at least partially met through provision of the authentication and/or billing mediation service apparatus and method described in the following detailed description, particularly when studied in conjunction with the drawings, wherein:

FIG. 1 comprises a block diagram as configured in accordance with various embodiments of the invention;

FIG. 2 comprises a flow diagram as configured in accordance with various embodiments of the invention;

FIG. 3 comprises a timing diagram as configured in accordance with an embodiment of the invention;

FIG. 4 comprises a timing diagram as configured in accordance with an embodiment of the invention;

FIG. 5 comprises a timing diagram as configured in accordance with an embodiment of the invention;

FIG. 6 comprises a flow diagram as configured in accordance with various embodiments of the invention; and

FIG. 7 comprises a timing diagram as configured in accordance with an embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are typically not depicted in order to facilitate a less obstructed view of these various embodiments of the present invention.

### DETAILED DESCRIPTION

Generally speaking, pursuant to these various embodiments, to facilitate or to compliment authentication, an implementing platform (such as a physical or virtual mediation server) receives SIP-compatible authentication message information as corresponds to an authentication message as sourced by a given subscriber and converts that SIP-compatible authentication message information into corresponding RADIUS protocol-compatible authentication message information. The latter is then suitable for use to facilitate authenticating the corresponding subscriber. Depending upon the embodiment, an SIP-compatible proxy can be used to receive the SIP-compatible authentication message information. In a preferred embodiment a RADIUS server uses the RADIUS protocol-compatible authentication message to facilitate the authentication process. In particular, this permits a RADIUS server to facilitate authentication of a given subscriber with respect to usage of a particular communication service such as a near-real-time multicast communication service.

Also pursuant to these various embodiments, billing information as pertains to such communication services as are provided to a given subscriber can be generated and then provided to the RADIUS server. For example, billing information as relates to provision of a near-real-time multicast communication service can be forwarded via an appropriate intermediary.

So configured, a RADIUS server, such as an AAA server, can be readily employed to support both SIP-based subscriber units (and their corresponding infrastructure) and considerable flexibility regarding billing for the provision of more complex services, such as near-real-time multicast communication services can more readily be accommodated. This in turn will likely facilitate a more rapid and widespread fielding of such services to the mutual benefit of both users and system operators.

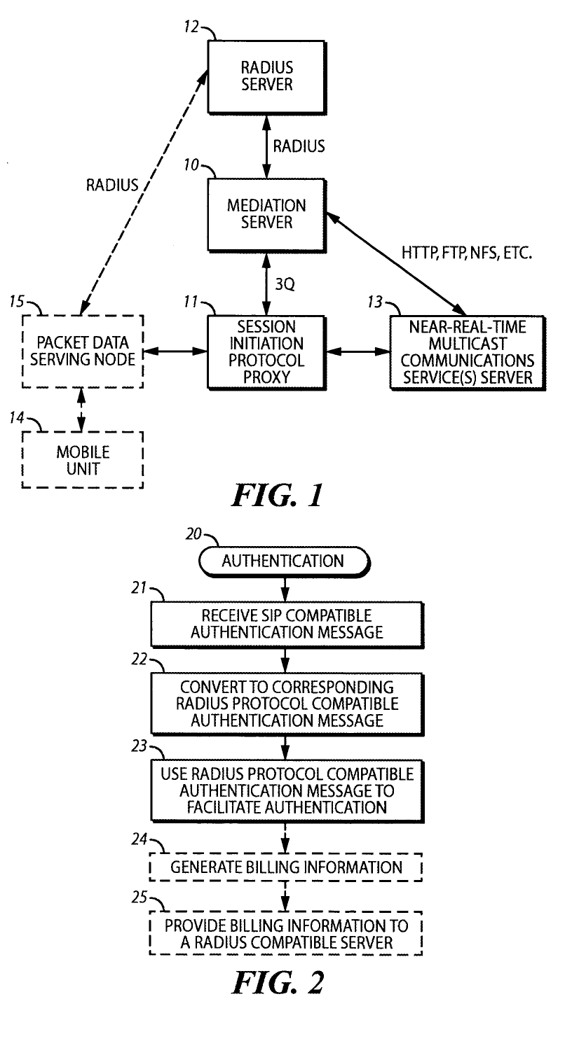

Referring now to FIG. 1, though the processes set forth herein can be realized in a variety of ways, a preferred approach makes use of a mediation server 10. As will be shown below, this mediation server 10 can comprise an authentication mediation server, a billing mediation server, or can support both activities as desired and/or as appropriate to a given application. It should be understood that such a mediation server 10 can comprise a physically discrete stand-alone or otherwise dedicated platform (as suggested by the illustration) or can be a virtual mediation server (where, for example, the mediation server functionality is distributed over multiple other platforms and/or where the mediation server functionality shares one or more enabling platforms with other functionality) as will be readily appreciated by those skilled in the art.

This mediation server 10, in a preferred embodiment, has an SIP compatible interface to facilitate communications regarding near-real-time multicast communication services with, for example, another SIP platform such as, but not limited to, an SIP proxy 11. Various SIP-friendly authentication protocols exist as offered by companies such as Cisco. As one specific example, this SIP compatible interface can comprise a 3Q compatible interface as offered by UTStarcom to thereby support SIP-based 3Q communications regarding, for example, authentication of a mobile unit 14 seeking access to a near-real-time multicast communication service. (Those skilled in the art will recognize that 3Q comprises a proprietary AAA protocol and simply represents one illustrative example of an SIP compatible protocol and exchange vehicle; though 3Q will be referred to from time to time herein for ease of illustrating and exemplifying these embodiments, it will be understood that all such references shall be interpreted to include all presently known or hereafter developed SIP compatible connectivity tools. Those skilled in the art will also recognize that such a mobile unit 14 may often also communicate with such an SIP proxy 11 via one or more intermediary platforms such as, but not limited to, a packet data serving node 15.)

In addition, or in lieu of the SIP compatible interface, in a preferred approach the mediation server 10 can have a near-real-time multicast communications services server interface to permit compatible communications with, for example, a near-real-time multicast communications service(s) server 13 (which in turn may support, for example, so-called walkie talkie style communications that include point to point communications, point to multipoint communications, or both amongst the participants of one or more predefined groups). So configured, the mediation server 10 can obtain billing information from the near-real-time multicast communications service(s) server 13 regarding corresponding services as are provided to one or more subscribers. As will be detailed below, such an exchange of information can be facilitated via a file transfer mechanism (such as HTTP, FTP, NFS, and the like); that is, billing information as stored and/or aggregated by the near-real-time multicast communications service(s) server 13 in a local (or remote) memory can be accessed and called, in whole or in part, by the mediation server 10 using such transfer mechanisms in a manner otherwise generally well understood in the art.

Such billing information can assume a wide variety of billable events and/or criteria including, but not limited to:
a start time for a near-real-time multicast communication service;
an end time for a near-real-time multicast communication service;
an IP address of a near-real-time multicast communication server;
an IP address of an SIP compatible proxy;
identifying information for an initiating party of a near-real-time multicast communication; and/or
identifying information for a plurality of participants of a near-real-time multicast communication service.

With access to such billing information from the near-real-time multicast communication server 13, the mediation server 10 can, for example, serve to process such billing information to provide temporally parsed billing information as corresponds to portions of a given near-real-time multicast session (for example, individual transmissions as comprise discrete portions of a larger multi-party multi-transmission communication can be separately treated via this approach). As another example, the mediation server 10 can process such billing information to provide parsed billing information as individually corresponds to individual participants of a given near-real-time multicast session (to thereby permit, for example, each participant to be individually billed for part or all of a multi-party communication of this sort). Such examples are illustrative only and other processing options will occur to those skilled in the art. Such alternatives should be considered as being within the scope of these teachings.

So configured, the mediation server 10 can communicate compatibly regarding authentication information with SIP compatible devices/systems and/or can communicate compatibly with near-real-time multicast communications service(s) servers 13 regarding billing information. In a preferred embodiment, the mediation server 10 will further include a RADIUS server interface to facilitate providing information to a RADIUS server 12 (such as an AAA) regarding authentication communications and/or billing information as pertain to the facilitation and offering of near-real-time multicast communications services. (Depending upon the operational environment and architecture, other system elements, such as a packet data serving node 15, may also be able to communicate with this RADIUS server 12 in a manner otherwise understood in the art.)

Such a configuration permits the mediation server 10 to receive authentication and/or billing information as pertains to the offering of near-real-time multicast communications services and to compatibly forward that information to a RADIUS server that can utilize that information to facilitate communications via such a service. For example, the RADIUS server 12 can utilize authentication messages as sourced by an SIP-based mobile unit 14 and as translated via the mediation server 10 to a corresponding RADIUS presentation. In a similar manner, billing information as collected from a near-real-time multicast communications service(s) server 13 can be provided, in a processed or unprocessed form, to the RADIUS server to thereby facilitate billing in accordance with the billing criteria and plans of the service provider.

Such a platform, or such other platform as may be suitable to meet the needs of a given context and application, can serve to effect processes such as those set forth in FIG. 2. As illustrated in FIG. 2, an authentication process 20 can comprise first receiving 21 (at, for example, an authentication mediation server and as forwarded, for example, by an SIP compatible proxy) an SIP compatible authentication message that itself comprises information that corresponds to an authentication message as sourced by a given subscriber. In many instances, of course, a given mobile unit may already have been generally authenticated by the relevant RADIUS server (i.e., the AAA) pursuant to an earlier mediation via an intervening packet data serving node in accordance with well established prior art practice. Accordingly, for at least some purposes, there may not be a strong need to again authenticate the mobile unit with respect to a specific desire to access the near-real-time multicast communication service.

It may nevertheless be useful and desirable, however, to have the mobile unit share a separate SIP password with the mediation server noted above to thereby effect specific permission to let the mobile unit use session initiation protocol, so that, for example, the SIP infrastructure can subsequently decide whether or not to permit the mobile unit to ultimately use the near-real-time multicast communication service (where, for example, the SIP infrastructure may have predefined limitations regarding supplemental costs that can be assumed with respect to resource usage of the mobile unit). This process 20 can provide for conversion 22 of the SIP compatible authentication message information into corresponding RADIUS protocol compatible authentication message information (which conversion occurs, for example, in an authentication mediation server). The latter is then preferably used 23 (for example, by a RADIUS compatible server such as an AAA server) to facilitate authentication of the given subscriber. For example, the given subscriber can be authenticated with respect to usage of a particular communication service (such as but not limited to a near-real-time multicast communication service facilitated as desired to support one-to-one and/or one-to-many group voice communication services including VoIP communication services).

As one example, the mediation server can share a corresponding CHAP password with, for example, the RADIUS compatible AAA in order to essentially authenticate the mobile unit (though, at least in some instances, this authentication will be relatively procedural in nature). Viewed another way, authentication occurs when the mediation server returns the mobile unit's SIP password to the corresponding SIP proxy such that the SIP proxy can then perform standard SIP authentication for the mobile unit.

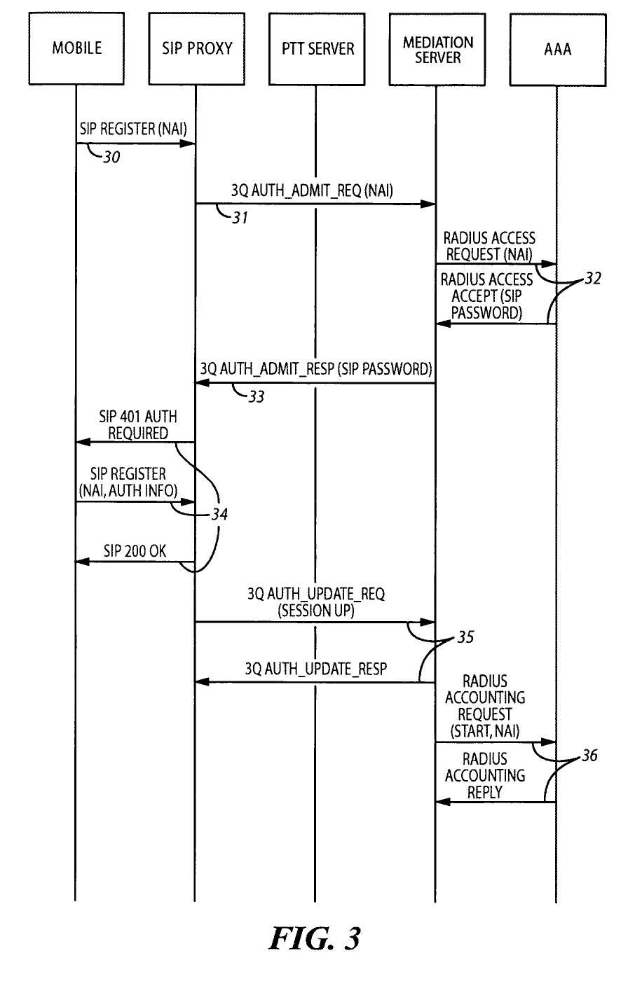

Referring momentarily to FIG. 3, a call flow diagram depicts an illustrative SIEP registration that culminates with successful authentication pursuant to an illustrative exchange as per one embodiment. A mobile unit transmits an SIP register message 30 that preferably includes its network access identifier (NAI) to its corresponding SIP proxy. The latter then sends a 3Q authorization request message 31 that preferably includes the mobile unit's NAI to the mediation server (to thereby facilitate retrieval of an appropriate SIP password from the AAA). The mediation server translates this 3Q message into a RADIUS access request (in particular, the mediation server can create a challenge and hash a CHAP password in order to effect a CHAP authentication in a compatible fashion with the AAA) to which the AAA can respond with a corresponding access acceptance that includes a desired SIP password 32 as pre-provisioned, for example, by the operator on a user-by-user basis.

The mediation server can then transmit the SIP password back to the SIP proxy using an appropriate 3Q authorization response message 33. The SIP proxy and the mobile unit can then engage in a short series of communications 34 wherein the SIP proxy transmits a 401 authorization required message to the mobile unit (which message contains a challenge that may be different than the challenge generated by the mediation server as appropriate to the needs and/or requirements of a given implementation. The mobile unit then re-registers using SIP with the appropriate authentication fields filled out accordingly. The SIP proxy then verifies the mobile unit and sends an SIP 200 OK message to effect registration of the mobile unit on the SIP infrastructure.

In a preferred approach, the SIP proxy then transmits a 3Q authorization update request message to the mediation server to indicate the successful authentication of the mobile unit to which the mediation server can respond with a 3Q authentication update response that acknowledges this communication 35. The mediation server and the AAA then conduct a short communication 36 wherein the mediation server sends a RADIUS accounting request (i.e., a “start” request) to the AAA and the AAA responds with a corresponding accounting reply.

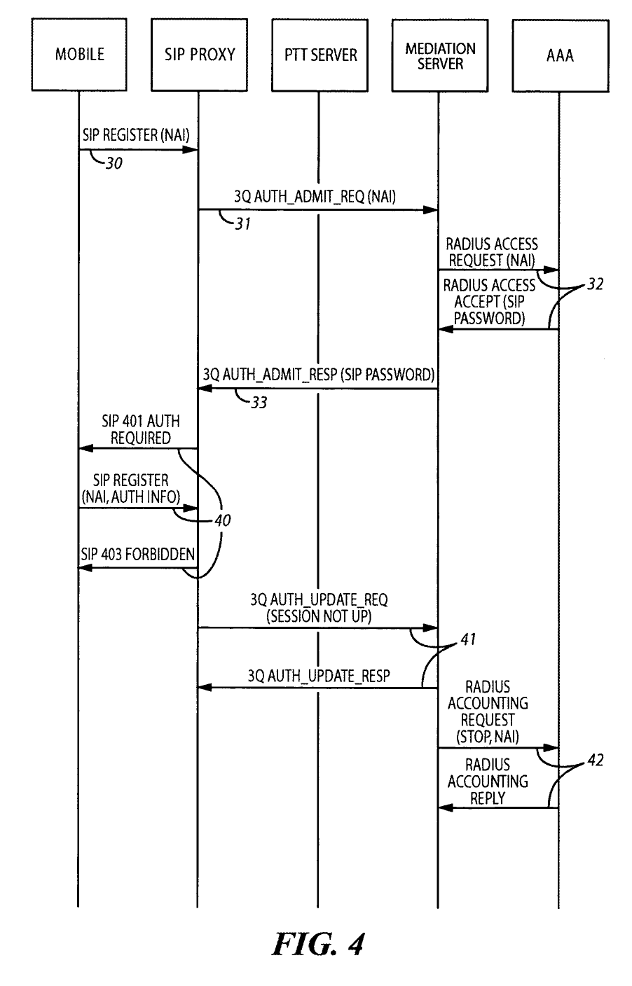

Such a series of exchanges will serve to effect a successful registration of a mobile unit notwithstanding the intent and need of the mobile unit to access a non-SIEP-based near-real-time multicast communication service. There will be circumstances and occasions, of course, when such authentication should in fact be unsuccessful (when, for example, the given subscriber is not previously authorized to use such a service or when someone using a cloned mobile unit seeks to gain access to the offered service). For example, and referring momentarily to FIG. 4, the authentication flow can begin as described above up through transmission by the mediation server of a 3Q message 33 that includes the SIP password. During the next series of exchanges 40, the SIP proxy sends a 401 authorization required message to the mobile unit (again, with an included challenge that is different from the challenge generated by the mediation server). In this example, while the mobile unit re-registers with the SIP proxy with the appropriate fields filled out, the fields in this example will not contain acceptable authentication information as the correct information for such SIP-based services was not provisioned to the mobile unit by the AAA pursuant to the earlier described exchange. In this event, the SIP proxy responds with an SIP 403 “forbidden” message to indicate unsuccessful authentication of the mobile unit. In a subsequent communication exchange 41, the SIP proxy sends a 3Q message to the mediation server to notify the latter of the unsuccessful authentication of the mobile unit to which the mediation server responds with an appropriate acknowledgement message. In a final communication exchange 42, the mediation server transmits an accounting “stop” request to the RADIUS server (i.e., the AAA in this example) that preferably contains a code that corresponds to the basis or cause that corresponds to the authentication failure to which the RADIUS server responds with a RADIUS accounting reply.

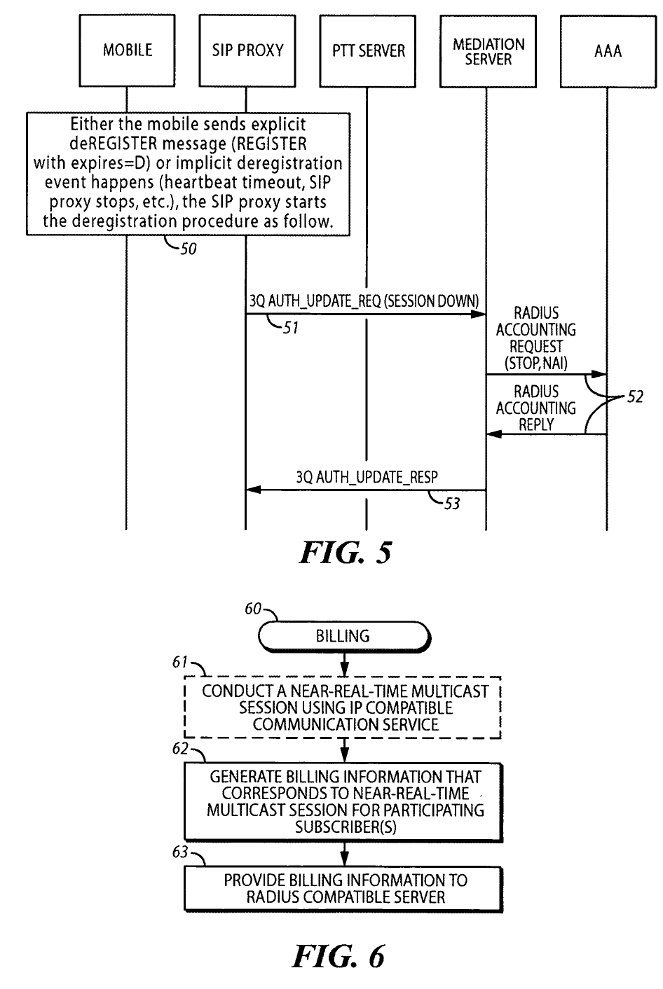

Once registered, a given mobile unit may remain registered with the SIP infrastructure for some period of time and may engage in one or more near-real-time multicast communication sessions. At some point it may be desired to deregister the mobile unit from the SIP infrastructure (with such deregistration being either mobile unit initiated or SIP proxy initiated, for example, as appropriate or as desired). With momentary reference to FIG. 5, the SIP proxy can determine 50 that the mobile has deregistered and transmit 51 a 3Q message to the mediation server to notify the latter of this event. The mediation server can conduct an exchange 52 with the AAA by transmitting a RADIUS account “stop” request and receiving a corresponding RADIUS accounting reply. The latter can then trigger transmission of a 3Q message 53 from the mediation server to the SIP proxy to indicate this updated condition.

Such a process will permit an SIP-compatible mobile unit to become authorized to use a near-real-time multicast communication service notwithstanding the use of a RADIUS server that administers such authentication while lacking a native compatibility with session initiation protocol. Optionally, but in a preferred embodiment (and referring again to FIG. 2), this process 20 will also facilitate the generation 24 of billing information that pertains to the communication service as is provided to the given subscriber and will further effect provision 25 of that billing information to a RADIUS compatible server (such as, for example, a same RADIUS server that facilitates the authentication process noted above.

When providing billing information regarding a near-real-time multicast communication service, there are a number of useful session parameters that can be used, alone or in combination, to permit a variety of billing possibilities. A number of potential billing criteria were set forth above. Other possibilities also exist, however. For example, when the billing information corresponds to a portion of a near-real-time multicast communication session, that billing information can include one or more of:
identifying information for a particular participant of the near-real-time multicast session;
a start time for the portion of the near-real-time multicast session;
an end time for the portion of the near-real-time multicast session;
a measure of data as was communicated during the portion of the near-real-time multicast session;
an amount of transmission time as occurred during the portion of the near-real-time multicast session;
an amount of reception time as occurred during the near-real-time multicast session;
identifying information regarding a voice codec (to facilitate, for example, billing a higher amount for a codec that uses less compression as compared to other available codecs);
total session initiation protocol bytes as were transmitted during the portion of the near-real-time multicast session; and
total session initiation protocol bytes as were received during the portion of the near-real-time multicast session.

With reference to FIG. 6, this billing process 60 will correspond to the conduct 61 of a near-real-time multicast session that uses, for example, IP compatible communication services such as voice-over-IP. More particularly, this billing process 60 will effect the generation 62 of billing information that corresponds to the near-real-time multicast session for one (or more than one up to and including all of the session participants) of the participating subscribers (reflecting, for example, the transmission activities of the subscriber(s), the reception activities of the subscriber(s), the total payload transmitted or received by the subscriber(s), and so forth). This billing information, when generated by the mediation server, can then be provided 63 to the RADIUS compatible server (i.e., in this example, to the AAA).

As already noted, the basic billing information will be captured and retained by the communication service server. The mediation server can use an appropriate data extraction tool or process to access that information. Once obtained, the mediation server can then process the billing information to yield the desired form and substance. The resultant processed billing information can then be forwarded to the AAA for a more final accounting.

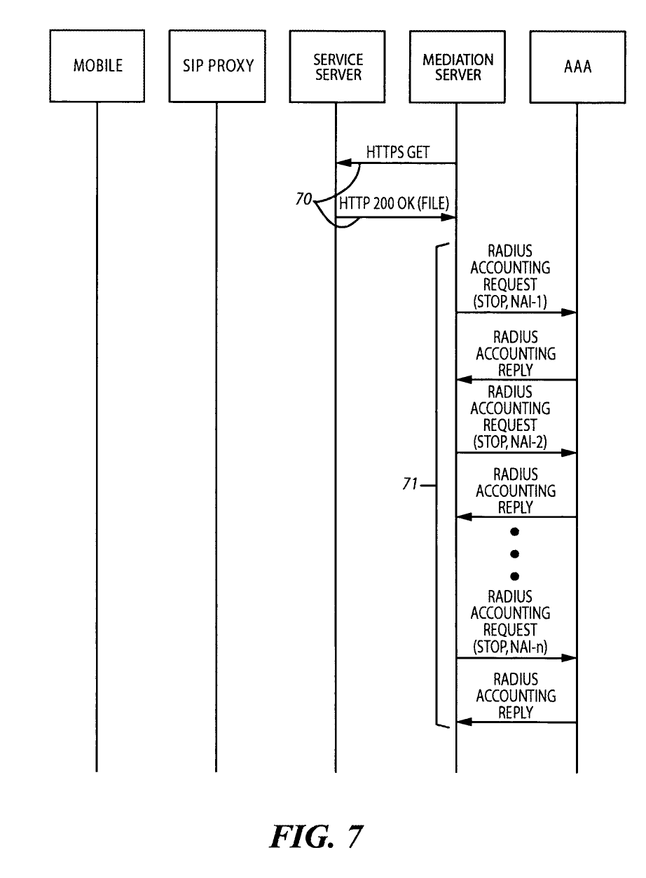

As one illustration, and referring now to FIG. 7, the mediation server can conduct an exchange 70 with the service server (such as a near-real-time multicast communication service server) by essentially logging on to the service server via secure HTTP (or such other information exchange process as may be suitable to meet the needs of a given application) and then downloading the relevant billing file for the session, or session portion, as may be desired. The mediation server then conducts one or more RADIUS accounting message exchanges 71 with the AAA to provide the latter with the necessary billing information. For example, for a given session, there may be one such exchange for each session participant. As another example, for a given session, there may be one such exchange for each transmission by any session participant. As a general principle, there can be one such exchange to correspond to each parsed and/or otherwise discrete billing event as may be extracted by the mediation server upon processing the raw billing data as was received from the service server.

Pursuant to these various embodiments, a communication service, such as a near-real-time multicast communication service, can be provided to a given mobile unit with attendant authentication and billing flexibility notwithstanding systemic use of SIP, RADIUS, and file transfer practices in a manner not previously practiced or imagined.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

1. A method comprising:
receiving session initiation protocol compatible authentication message information as corresponds to an authentication message as sourced by a given subscriber;
converting the session initiation protocol compatible authentication message information into corresponding RADIUS protocol compatible authentication message information;
using the RADIUS protocol compatible authentication message information to facilitate authentication of the given subscriber.

2. The method of claim 1 wherein receiving session initiation protocol compatible authentication message information comprises using a session initiation protocol compatible proxy to receive the session initiation protocol compatible authentication message information.

3. The method of claim 1 wherein converting the session initiation protocol compatible authentication message information comprises using an authentication mediation server to convert the session initiation protocol compatible authentication message.

4. The method of claim 3 wherein using an authentication mediation server comprises using a physically discrete authentication mediation server.

5. The method of claim 3 wherein using an authentication mediation server comprises using a virtual authentication mediation server.

6. The method of claim 1 wherein using the RADIUS protocol compatible authentication message information to facilitate authentication of the given subscriber comprises using a RADIUS server to use the RADIUS protocol compatible authentication message information to facilitate authentication of the given subscriber.

7. The method of claim 1 wherein using the RADIUS protocol compatible authentication message information to facilitate authentication of the given subscriber comprises using the RADIUS protocol compatible authentication message information to facilitate authentication of the given subscriber with respect to usage of a particular communication service by the given subscriber.

8. The method of claim 7 wherein using the RADIUS protocol compatible authentication message information to facilitate authentication of the given subscriber with respect to usage of a particular communication service by the given subscriber comprises facilitating authentication of the given subscriber with respect to usage of a particular communication service comprising a near-real-time multicast communication service.

9. The method of claim 8 wherein the near-real-time multicast communication service comprises a one-to-many communication service.

10. The method of claim 9 wherein the one-to-many communication service comprises a voice communication service.

11. The method of claim 10 wherein the voice communication service comprises a voice-over-Internet-Protocol communication service.

12. The method of claim 1 and further comprising:
generating billing information that pertains to a communication service as is provided to the given subscriber;
providing the billing information to a RADIUS compatible server.

13. The method of claim 12 wherein generating billing information that pertains to a communication service as is provided to the given subscriber comprises generating billing information that pertains to a near-real-time multicast communication service as is provided to the given subscriber.

14. The method of claim 13 wherein generating billing information that pertains to a near-real-time multicast communication service as is provided to the given subscriber comprises generating billing information that corresponds, at least in part, to at least one of:
a start time for a near-real-time multicast communication service;
an end time for a near-real-time multicast communication service;
an Internet Protocol address of a near-real-time multicast communication service server;
an Internet Protocol address of a session initiation protocol compatible proxy;
identifying information for an initiating party of a near-real-time multicast communication; and
identifying information for a plurality of participants of a near-real-time multicast communication.

15. The method of claim 13 wherein generating billing information that pertains to a near-real-time multicast communication service as is provided to the given subscriber comprises generating billing information for a portion of a near-real-time multicast session that comprises at least one of:
identifying information for a particular participant of the near-real-time multicast session;
a start time for the portion of the near-real-time multicast session;
an end time for the portion of the near-real-time multicast session;
a measure of data as was communicated during the portion of the near-real-time multicast session;
an amount of transmission time as occurred during the portion of the near-real-time multicast session;
an amount of reception time as occurred during the near-real-time multicast session;
identifying information regarding a voice codec;
total session initiation protocol bytes as were transmitted during the portion of the near-real-time multicast session; and
total session initiation protocol bytes as were received during the portion of the near-real-time multicast session.

16. A method comprising, in conjunction with conducting a near-real-time multicast session using an Internet Protocol compatible communication service:
generating billing information that pertains to the near-real-time multicast session as regards at least one given participating subscriber;
providing the billing information to a RADIUS compatible server.

17. The method of claim 16 wherein generating billing information comprises generating billing information that corresponds, at least in part, to at least one of:
a start time for the near-real-time multicast session;
an end time for the near-real-time multicast session;
an Internet Protocol address of a near-real-time multicast communication service server;
an Internet Protocol address of a session initiation protocol compatible proxy;
identifying information for an initiating party of the near-real-time multicast session; and
identifying information for a plurality of participants of the near-real-time multicast session.

18. The method of claim 16 wherein generating billing information comprises generating billing information for a portion of the near-real-time multicast session that comprises at least one of:
identifying information for a particular participant of the near-real-time multicast session;
a start time for the portion of the near-real-time multicast session;
an end time for the portion of the near-real-time multicast session;
a measure of data as was communicated during the portion of the near-real-time multicast session;
an amount of transmission time as occurred during the portion of the near-real-time multicast session;
an amount of reception time as occurred during the near-real-time multicast session;
identifying information regarding a voice codec;
total session initiation protocol bytes as were transmitted during the portion of the near-real-time multicast session; and
total session initiation protocol bytes as were received during the portion of the near-real-time multicast session.

19. The method of claim 16 wherein generating billing information that pertains to the near-real-time multicast session as regards at least one given participating subscriber comprises generating billing information that pertains to the near-real-time multicast session as regards a plurality of participating subscribers.

20. The method of claim 19 wherein providing the billing information to a RADIUS compatible server comprises:
segregating the billing information as pertains to each participating subscriber to provide segregated billing information;
providing the segregated billing information to the RADIUS compatible server.

21. The method of claim 20 wherein providing the segregated billing information to the RADIUS compatible server further comprises providing temporally parsed segregated billing information to the RADIUS compatible server.

22. The method of claim 16 wherein:
generating billing information that pertains to the near-real-time multicast session as regards at least one given participating subscriber comprises receiving, by a billing mediation server, at least some services usage information from a near-real-time multicast session server; and
providing the billing information to a RADIUS compatible server comprises the billing mediation server providing the billing information to the RADIUS compatible server.

23. The method of claim 16 and further comprising:
receiving session initiation protocol compatible authentication message information as corresponds to an authentication message as sourced by a given subscriber in conjunction with the near-real-time multicast session;
converting the session initiation protocol compatible authentication message information into corresponding RADIUS protocol compatible authentication message information;
using the RADIUS protocol compatible authentication message information to facilitate authentication of the given subscriber to participate in the near-real-time multicast session.

24. The method of claim 23 wherein receiving session initiation protocol compatible authentication message information comprises using a session initiation protocol compatible proxy to receive the session initiation protocol compatible authentication message information.

25. The method of claim 23 wherein converting the session initiation protocol compatible authentication message information comprises using an authentication mediation server to convert the session initiation protocol compatible authentication message.

26. The method of claim 25 wherein using an authentication mediation server comprises using a billing mediation server as an authentication mediation server.

27. The method of claim 26 wherein using a billing mediation server comprises using a physically discrete billing mediation server.

28. The method of claim 26 wherein using a billing mediation server comprises using a virtual billing mediation server.

29. The method of claim 23 wherein using the RADIUS protocol compatible authentication message information to facilitate authentication of the given subscriber to participate in the near-real-time multicast session comprises using a RADIUS server to use the RADIUS protocol compatible authentication message information to facilitate authentication of the given subscriber to participate in the near-real-time multicast session.

30. An authentication and billing mediation server comprising:
a session initiation protocol compatible interface to facilitate authentication communications regarding near-real-time multicast communication services;
a near-real-time multicast communications services server interface to facilitate receiving billing information from a near-real-time multicast communications services server regarding a multi-participant near-real-time multicast session;
a RADIUS server interface to facilitate providing information to a RADIUS server regarding:
authentication communications; and
the billing information.

31. The authentication and billing mediation server of claim 30 wherein the session initiation protocol compatible interface comprises a 3Q compatible interface.

32. The authentication and billing mediation server of claim 30 wherein the session initiation protocol compatible interface operably couples to a session initiation protocol proxy.

33. The authentication and billing mediation server of claim 30 wherein the billing information comprises at least one of:
a start time for a near-real-time multicast communication service;
an end time for a near-real-time multicast communication service;
an Internet Protocol address of a near-real-time multicast communication service server;
an Internet Protocol address of a session initiation protocol compatible proxy;
identifying information for an initiating party of a near-real-time multicast communication; and
identifying information for a plurality of participants of a near-real-time multicast communication.

34. The authentication and billing mediation server of claim 30 and further comprising billing means for processing the billing information to provide temporally parsed billing information as corresponds to portions of a given near-real-time multicast session.

35. The authentication and billing mediation server of claim 30 and further comprising billing means for processing the billing information to provide parsed billing information as individually corresponds to individual participants of a given near-real-time multicast session.

36. The authentication and billing mediation server of claim 35 wherein the billing means further processes the billing information to provide temporally parsed billing information as corresponds to portions of a given near-real-time multicast session.
